(19) United States
(12) Patent Application Publication
(10) Pub. No.: US 2023/0032074 A1
(43) Pub. Date: Feb. 2, 2023

(54) VEHICLE HAVING FUNCTION OF LIMITING DRIVING FORCE

(71) Applicant: TOYOTA JIDOSHA KABUSHIKI KAISHA, Toyota-shi (JP)

(72) Inventors: Koji HOKOI, Toyota-shi (JP); Yusuke YAMANISHI, Nagoya-shi (JP)

(73) Assignee: TOYOTA JIDOSHA KABUSHIKI KAISHA, Toyota-shi (JP)

(21) Appl. No.: 17/830,483

(22) Filed: Jun. 2, 2022

(30) Foreign Application Priority Data
Aug. 2, 2021 (JP) 2021-126724

(51) Int. Cl. B60W 30/18; B60W 20/10

(52) U.S. Cl. CPC B60W 30/18172; B60W 20/10; B60W 2520/10; B60W 2520/28; B60W 2710/06; B60W 2710/08

(57) ABSTRACT

A vehicle includes a drive source that supplies a driving force to a drive wheel, a switch, and a controller that puts a first limitation on the driving force or puts a second limitation on the driving force when the switch is operated, the second limitation being smaller than the first limitation.

### CROSS-REFERENCE TO RELATED APPLICATION

This application is based upon and claims the benefit of priority of the prior Japanese Patent Application No. 2021-126724, filed on Aug. 2, 2021, the entire contents of which are incorporated herein by reference.

### FIELD OF THE INVENTION

The present disclosure relates to a vehicle, particularly to a vehicle having a function of limiting a driving force.

### BACKGROUND

In vehicles such as hybrid vehicles, there is a technique to prevent the slippage of drive wheels by limiting the driving force as disclosed in, for example, Japanese Patent Application Publication No. 2007-099081.

### SUMMARY OF THE INVENTION

Limitation on the driving force decreases the driving performance on off-road surfaces or other road surfaces. Increasing of the driving force improves the driving performance. However, when the drive wheel holds the road, the rotation speed of the drive wheel rapidly varies. This may put a heavy load on the parts of the vehicle. Therefore, the objective of the present disclosure is to provide a vehicle capable of achieving both good driving performance and protection of parts.

The above objective is achieved by a vehicle including: a drive source that supplies a driving force to a drive wheel; a switch; and a controller that puts a first limitation on the driving force or puts a second limitation on the driving force when the switch is operated, the second limitation being smaller than the first limitation.

The drive source may be an electric motor, and the vehicle may further include a battery that supplies electric power to the electric motor and can be charged by the electric motor.

The switch may include a first switch and a second switch, and the controller may put the first limitation on the driving force when the first switch is operated, and may put the second limitation on the driving force when the second switch is operated.

The controller may acquire a slipping speed based on a speed of a vehicle body and a speed of the drive wheel, and when the second limitation is put, the controller may adjust a limitation according to the slipping speed on the driving force to be less than that when the first limitation is put.

The controller may decrease the driving force as the slipping speed increases.

### Effects of the Invention

According to the present disclosure, it is possible to provide a vehicle that achieves both good driving performance and protection of parts.

### BRIEF DESCRIPTION OF THE DRAWINGS

FIG. 1 is a schematic diagram illustrating a vehicle in accordance with an embodiment;

FIG. 2 is a flowchart of a process executed by an ECU; and

FIG. 3 illustrates limitation on the driving force.

### DETAILED DESCRIPTION

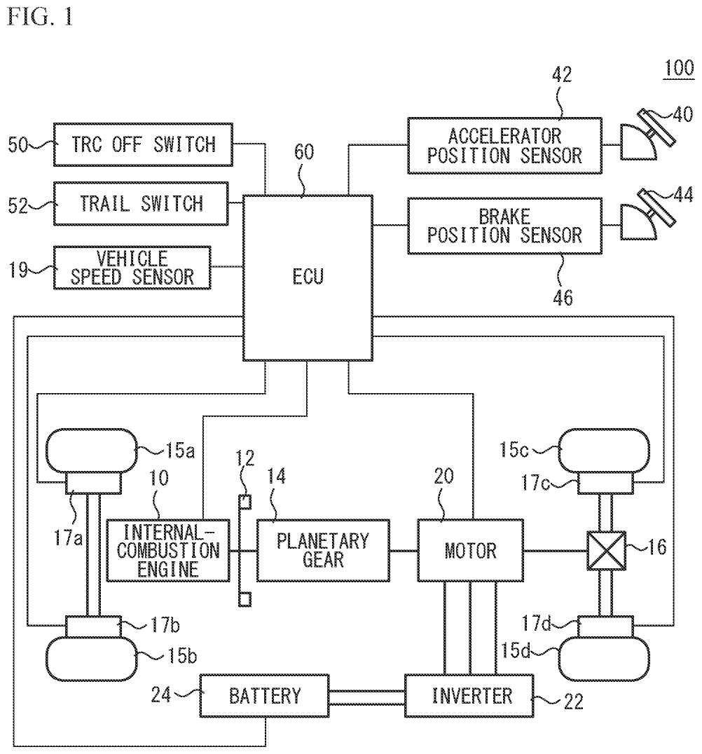

Hereinafter, with reference to the accompanying drawings, a vehicle in accordance with an embodiment will be described. FIG. 1 is a schematic diagram illustrating a vehicle 100 in accordance with the embodiment. The vehicle 100 illustrated in FIG. 1 is a hybrid electric vehicle (HEV) having an internal-combustion engine 10 and a motor 20 as drive sources.

A planetary gear 14 is coupled to the crankshaft (not illustrated) of the internal-combustion engine 10 through a damper 12, and is coupled to the motor 20. The motor 20 is coupled to wheels 15c and 15d through a differential gear 16. The driving forces generated by the internal-combustion engine 10 and the motor 20 are transmitted to the wheels 15c and 15d to cause the vehicle 100 to run. In the example of FIG. 1, the wheels 15c and 15d of four wheels are drive wheels, and the driving force is transmitted to the wheels 15c and 15d from the drive source. Wheels 15a and 15b are non-drive wheels. All of the wheels 15a, 15b, 15c, and 15d may be drive wheels.

The internal-combustion engine 10 is a gasoline or diesel engine that produces motion using fuel such as, for example, gasoline or light oil.

The motor 20 functions as an electric motor that generates driving force and also functions as a power generator that generates electric power. The motor 20 is electrically connected to a battery 24 through an inverter 22. The battery 24 is a rechargeable battery, such as a lithium-ion secondary battery or a nickel-metal-hydride secondary battery.

The inverter 22 converts the direct-current power generated by the battery 24 to the alternating-current power to provide it to the motor 20. The motor 20 rotates with the supply of electric power and generates driving force. The inverter 22 converts the alternating-current power generated by the motor 20 to the direct-current power to provide it to the battery 24. The supply of electric power charges the battery 24. The battery 24 may be charged by the electric power supplied from, for example, an external power source.

The vehicle 100 includes wheel speed sensors 17a to 17d, and a vehicle speed sensor 19. The wheel speed sensor 17a detects the rotating speed of the wheel 15a (the wheel speed). The wheel speed sensor 17b detects the wheel speed of the wheel 15b. The wheel speed sensor 17c detects the wheel speed of the wheel 15c. The wheel speed sensor 17d detects the wheel speed of the wheel 15d. The vehicle speed sensor 19 detects the speed of the vehicle 100 (the vehicle body speed).

The driver manipulates the vehicle 100 using an accelerator pedal 40 and a brake pedal 44. An accelerator position sensor 42 detects the amount of depression of the accelerator pedal 40 (the accelerator opening degree). A brake position sensor 46 detects the amount of depression of the brake pedal 44.

The vehicle 100 includes a traction control (TRC) off switch 50 and a trail switch 52. The TRC off switch 50 and the trail switch 52 are switches for controlling the driving force. The TRC off switch 50 and the trail switch 52 are switches that can be operated by a person. The TRC off switch 50 and the trail switch 52 may be physical switches such as buttons or levers, or may be buttons that are displayed on a screen and can be tapped. The TRC off switch 50 and the trail switch 52 are disposed near the driver seat. For example, one switch may function as the TRC off switch 50 and the trail switch 52. Whether the switch functions as the TRC off switch 50 or the trail switch 52 is determined based on, for example, the number of operations or the time of the operation. For example, operating the switch once is to operate the TRC off switch 50, and operating the switch twice is to operate the trail switch 52. Pressing the switch for a short time is to operate the TRC off switch 50, and pressing the switch for a long time is to operate the trail switch 52.

An electronic control unit (ECU) 60 is a control device including a computing device such as a central processing unit (CPU), and storage devices such as a flash memory, a read only memory (ROM), and a random access memory (RAM). The ECU 60 includes, for example, an engine ECU, a motor ECU, a battery ECU, and a hybrid (HV) ECU. The engine ECU controls the internal-combustion engine 10. The motor ECU controls the motor 20. The battery ECU controls the battery 24. The HVECU controls the driving mode, and switches between, for example, the charge sustaining (CS) mode and the charge depleting (CD) mode.

The ECU 60 is electrically connected to the wheel speed sensors 17a, 17b, 17c, and 17d, the vehicle speed sensor 19, the accelerator position sensor 42, and the brake position sensor 46. The ECU 60 acquires the speed of the wheel 15a detected by the wheel speed sensor 17a, the speed of the wheel 15b detected by the wheel speed sensor 17b, the speed of the wheel 15c detected by the wheel speed sensor 17c, and the speed of the wheel 15d detected by the wheel speed sensor 17d. The ECU 60 acquires the speed of the vehicle 100 detected by the vehicle speed sensor 19. The ECU 60 calculates the difference between the wheel speed and the vehicle body speed (the slipping speed).

The ECU 60 acquires the state of charge (SOC) of the battery 24. The ECU 60 supplies electric power to the motor 20 from the battery 24 to rotate the motor 20. The vehicle 100 runs using the driving force generated by the motor 20. The power generated by the motor 20 is supplied to the battery 24, and the battery 24 is charged. The vehicle 100 may be driven by the cooperation between the internal-combustion engine 10 and the motor 20, or the vehicle 100 may be driven solely by the driving force of the combustion engine 10 without operating the motor 20.

The ECU 60 acquires the amount of depression of the brake pedal 44 detected by the brake position sensor 46. The ECU 60 activates the brakes (not illustrated) according to the amount of depression of the brake pedal 44 to decrease the rotation speeds of the wheels 15a to 15d.

The ECU 60 acquires the accelerator opening degree detected by the accelerator position sensor 42. The ECU 60 determines the driving force based on the accelerator opening degree, and controls the driving force by controlling, for example, the current flowing to the motor 20 and the supply amount of the fuel to the internal-combustion engine 10. The ECU 60 functions as a controller that controls the driving force, and can limit the driving force. The driving force is limited to a lower level by, for example, reduction in the current flowing to the motor 20 or reduction in the supply amount of the fuel to the internal-combustion engine 10.

The vehicle 10 may slip on off-road surfaces such as, for example, icy, snowy, or sandy surfaces. When the vehicle 10 slips, at least one of the wheels 15a, 15b, 15c, and 15d spins free, and its wheel speed increases. When the wheel spinning free holds the road, its wheel speed decreases. The change from the state in which the vehicle is slipping (hereinafter, referred to as a slipping state) to the state in which the wheel holds the road (hereinafter, referred to as a road-holding state) causes the rapid change in the wheel speed, which puts a load on the parts of the vehicle 100. By lowering the driving force, the slippage of the vehicle 100 is inhibited, and the parts can be protected.

On the other hand, to improve the off-road driving performance, it is effective to increase the driving force. However, increasing of the driving force puts a load on the parts when the slipping state goes to the road-holding state. The driver controls the driving force by operating the TRC off switch 50 and the trail switch 52. When neither the TRC off switch 50 nor the trail switch 52 is operated, the ECU 60 does not limit the driving force. When the TRC off switch 50 is operated, the ECU 60 puts a first limitation on the driving force. When the trail switch 52 is operated, the ECU 60 puts a second limitation on the driving force. The first limitation limits the driving force more than the second limitation. The second limitation limits the driving force more than when there is no operation of the switch, and limits the driving force less than the first limitation.

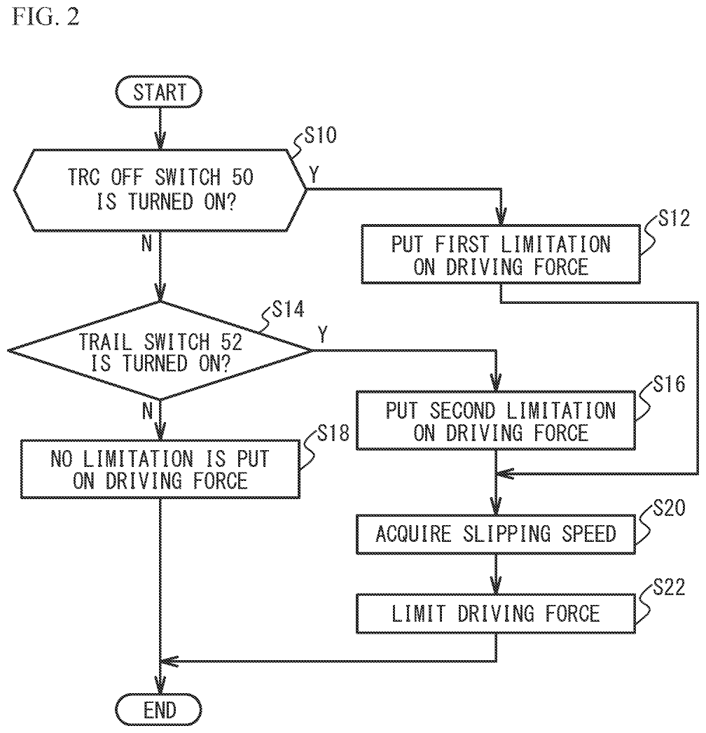

FIG. 2 is a flowchart of an exemplary process executed by the ECU 60. As illustrated in FIG. 2, the ECU 60 determines whether the TRC off switch 50 is turned on (step S10). When the user operates the TRC off switch 50, the TRC off switch 50 is turned on. In this case, the determination in step S10 becomes Yes, and the ECU 60 puts the first limitation on the driving force (step S12). The ECU 60 acquires the slipping speed (step S20). The ECU 60 calculates the driving force after the limitation, for example, by multiplying the accelerator opening degree by the limitation ratio corresponding to the slipping speed. The electric power corresponding to the calculated driving force is supplied to the motor 20 to limit the driving force (step S22).

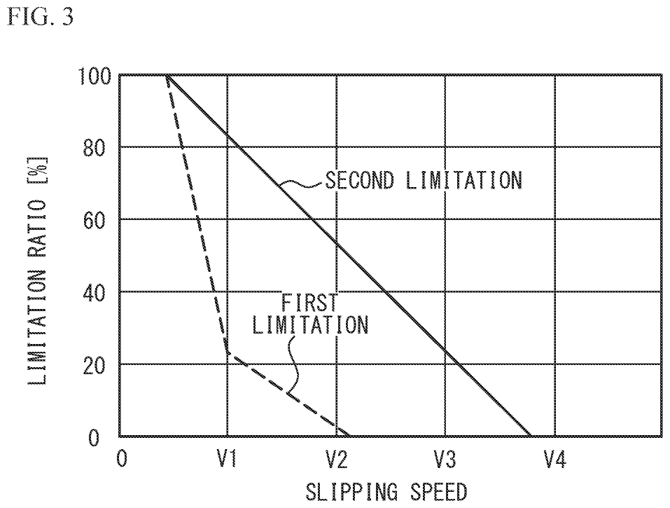

When the determination in step S10 is No, the ECU 60 determines whether the trail switch 52 is turned on (step S14). When the determination is Yes, the ECU 60 puts the second limitation on the driving force (step S16). The ECU 60 acquires the slipping speed (step S20). As described later in FIG. 3, the driving force in the second limitation is greater than the driving force in the first limitation. The electric power corresponding to the calculated driving force is supplied to the motor 20 to limit the driving force (step S22).

When the determination in step S10 and the determination in S14 are both No, the ECU 60 does not put the limitation on the driving force (step S18). After step S18 or S22, the process ends.

FIG. 3 is a diagram illustrating the limitation on the driving force. The horizontal axis represents the slipping speed. The vertical axis represents the limitation ratio to the driving force. The limitation ratio is the ratio of the magnitude of the driving force when the limitation is put to the magnitude of the driving force without limitation (100%). For example, a limitation ratio of 20% means that the driving force when the limitation is put is limited to 20% of the magnitude of the driving force without limitation. The slipping speed is the difference between the wheel speed and the vehicle body speed.

The dashed line in FIG. 3 indicates an example in which the TRC off switch 50 is operated and the first limitation is put on the driving force. The solid line indicates an example in which the trail switch 52 is operated and the second limitation is put on the driving force.

As illustrated in FIG. 3, at a slipping speed near 0, the driving force is not limited. As the slipping speed increases, the limitation ratio of the driving force increases. In the case of the first limitation, the limitation ratio is approximately 20% at a slipping speed of V1. The limitation ratio is 10% or less at a slipping speed of V2, which is greater than V1. At a slipping speed greater than V2, the limitation ratio is 0%, and the driving force is not generated.

In the case of the second limitation, at a slipping speed of V1, the limitation ratio is approximately 85%, and at a slipping speed of V2, the limitation ratio is approximately 50%. At a slipping speed of V3, which is greater than V2, the limitation ratio is approximately 30%. The limitation ratio varies linearly with the slipping speed. At a slipping speed close to V4, the limitation ratio is 0%.

As illustrated in FIG. 3, the driving force is limited by the first limitation and the second limitation, according to the slipping speed. The second limitation limits the driving force less than the first limitation. In other words, in the second limitation, the driving force is larger than that in the first limitation, and the driving performance improves. FIG. 3 illustrates an example of the driving force, and does not intend to suggest any limitation. For example, the limitation ratio in the first limitation may vary at a constant rate with respect to the slipping speed. The limitation ratio in the second limitation may vary while its slope changes with respect to the slipping speed. The limitation ratio may vary according to a straight line having the slipping speed as a variable, or may vary according to a curve having the slipping speed as a variable.

In the present embodiment, the ECU 60 puts the first limitation on the driving force when the TRC off switch 50 is operated. When the trail switch 52 is operated, the ECU 60 puts the second limitation, which is smaller than the first limitation, on the driving force. By putting the second limitation on the driving force, the parts are protected. The second limitation is smaller than the first limitation. Therefore, the driving force increases, improving the driving performance.

When the driving force is not limited, the driving performance is high compared with that when the driving force is limited. However, a load is put on the parts because of the rapid change in the wheel speed between the slipping state and the road-holding state. For example, by causing a large current to flow to the motor 20, the torque of the motor 20 is increased to increase the driving force. In the slipping state, the wheel rotates at high speed, and the rotation speed of the motor 20 is also high. When the state changes to the road-holding state, the wheel speed of the wheel rapidly decreases, and the rotation speed of the motor 20 also decreases. Between the slipping state and the road-holding state, the current flowing to the motor 20 rapidly decreases. The power that has been supplied to the motor 20 is input to the battery 24, which results in overcharging of the battery 24.

On the other hand, when the first limitation is put on the driving force, the driving force is kept low. Since the driving force becomes low, the rotation speed of the motor 20 decreases, and the current input to the motor 20 decreases. When the slipping state goes to the road-holding state, the electric power input to the battery 24 becomes small. Thus, overcharging of the battery 24 is inhibited. However, since the driving force is largely limited, the driving performance decreases.

In the present embodiment, the second limitation is put on the driving force. The limitation on the driving force decreases the current input to the motor 20. When the slipping state goes to the road-holding state, the electric power input to the battery 24 decreases. Therefore, overcharging of the battery 24 is inhibited, and the battery 24 is protected. In the second limitation, the limitation on the driving force is less than that in the first limitation. That is, the driving force in the second limitation is larger than that in the first limitation. Therefore, the driving performance improves. As a result, good driving performance and the protection of the parts such as the battery 24 are both achieved.

The ECU 60 limits the driving force according to the slipping speed. As illustrated in FIG. 3, at the same slipping speed, the driving force in the second limitation is equal to or greater than three times the driving force in the first limitation. Greater driving force improves the driving performance. The driving force in the second limitation is limited to less than 100%. Since overcharging of the battery 24 or the like is inhibited, the parts can be protected. The rapid change in the rotation speed of the motor 20 is also reduced. The rapid change in the current flowing to the motor 20 is reduced, and the motor 20 is protected.

As illustrated in FIG. 3, the ECU 60 lowers the driving force as the slipping speed increases. When the slipping speed is large, the rotation speed of the motor 20 may rapidly decrease at the time of the drive wheel holding the road. By lowering the driving force, the rotation speed of the motor 20 is suppressed to a low level. By reducing the change in the rotation speed of the motor 20 when the slipping state goes to the road-holding state, overcharging of the battery 24 can be inhibited.

The vehicle 100 may include the TRC off switch 50 and the trail switch 52. One switch may function as the TRC off switch 50 and the trail switch 52, as described above.

The vehicle 100 may be a plug-in hybrid vehicle and an electric vehicle in addition to the hybrid vehicle. Overcharging of the battery 24 due to the change in the rotation speed of the motor 20 can be inhibited, and thereby, the battery 24 can be protected.

Although some embodiments of the present invention have been described in detail, the present invention is not limited to the specific embodiments but may be varied or changed within the scope of the present invention as claimed.

What is claimed is:

1. A vehicle comprising:
a drive source that supplies a driving force to a drive wheel;
a switch; and
a controller that puts a first limitation on the driving force or puts a second limitation on the driving force when the switch is operated, the second limitation being smaller than the first limitation.

2. The vehicle according to claim 1,
wherein the drive source is an electric motor, and
wherein the vehicle further comprises a battery that supplies electric power to the electric motor and can be charged by the electric motor.

3. The vehicle according to claim 1,
wherein the switch includes a first switch and a second switch, and
wherein the controller puts the first limitation on the driving force when the first switch is operated, and puts the second limitation on the driving force when the second switch is operated.

4. The vehicle according to claim 1,
wherein the controller acquires a slipping speed based on a speed of a vehicle body and a speed of the drive wheel, and
wherein when the second limitation is put, the controller adjusts a limitation according to the slipping speed on the driving force to be less than that when the first limitation is put.

5. The vehicle according to claim 4,
wherein the controller decreases the driving force as the slipping speed increases.
